(19) United States
(12) Patent Application Publication
(10) Pub. No.: US 2014/0312652 A1
(43) Pub. Date: Oct. 23, 2014

(54) MOTOR VEHICLE BODY

(71) Applicant: Flat Group Automobiles S.p.A., Torino (IT)

(72) Inventors: Sebastian Favaloro, Torino (IT); Giuseppe Antonio Soddu, Torino (IT)

(73) Assignee: Flat Group Automobiles S.p.A., Torino (IT)

(21) Appl. No.: 14/258,948

(22) Filed: Apr. 22, 2014

(30) Foreign Application Priority Data
Apr. 23, 2013 (IT) TO2013A000329

(51) Int. Cl. B62D 25/08

(52) U.S. Cl. CPC B62D 25/082
USPC 296/187.1

(57) ABSTRACT

A motor vehicle body has a structure defining a passenger compartment, two primary longitudinal struts, and two secondary longitudinal struts; the primary struts are arranged in lower positions and more inwards with respect to the secondary struts and are provided with front end portions adapted to support a front end of the motor vehicle; such front end portions are joined to the secondary struts by means of respective connection devices having respective intermediate portions extending along respective directions which are substantially symmetric with respect to a vertical centerline plane and diverge, extending backwards.

### The present invention relates to a motor vehicle body.

### BACKGROUND OF THE INVENTION

As is known, the body of motor vehicles is designed to meet requirements which allow to obtain an adequate safety for the passengers in the event of accidents.

With regard to frontal crashes, the front engine compartment of motor vehicles has two primary longitudinal struts and two secondary longitudinal struts, the struts having collapsible zones for absorbing energy resulting from crashes at relatively high speed. The primary struts extend so as to protrude from the passenger compartment structure at a height corresponding to the front wheelhouses and, at the end thereof, support the front end of the motor vehicle. The secondary struts extend so as to protrude from the uprights of the front doors, above the wheelhouses and therefore are arranged higher and more outwards.

The above described configuration allows to obtain excellent performance with regard to safety in the passenger compartment in the event of a frontal crash occurring against an obstacle approximately at the longitudinal centreline axis of the motor vehicle.

Nevertheless, the results are not as satisfactory when the frontal crash occurs with a relevant offset or deviation with respect to the longitudinal centreline axis and, therefore, involves substantially a front angle of the motor vehicle. In this event, the stress due to the crash is indeed unloaded mainly on the secondary strut arranged on the side involved by the frontal crash, and the primary struts are involved only minimally, therefore the plastic deformation of the body is not able to sufficiently absorb the crash energy.

To obtain better results, it is known to vary the configuration of the primary struts, by making them diverge so that they also intervene in the plastic deformation, when a frontal crash of the above described type occurs.

However, this configuration is more cumbersome, so that it preferably should be avoided.

### SUMMARY OF THE INVENTION

It is therefore the object of the present invention to provide a motor vehicle body, which allows to resolve the above described drawbacks in a simple and affordable way and, preferably, adopt a solution which may be installed in a simple manner and with a relatively low number of modifications on bodies provided with longitudinal struts of the above described type, without having to redesign such struts and without excessively increasing the overall weight and the dimensions of the body in the engine compartment.

According to the present invention, a motor vehicle body is provided, as defined in claim 1.

### BRIEF DESCRIPTION OF THE DRAWINGS

To better understand the present invention, a preferred embodiment thereof is now described, by way of non-limiting example, with reference to the accompanying drawings, in which:

FIG. 1 is a simplified front view, and with parts removed for clarity, of a motor vehicle provided with a preferred embodiment of the body according to the present invention;

FIG. 2 is a perspective top view, on enlarged scale, of the body of FIG. 1; and

FIG. 3 is a perspective bottom view of a detail of FIG. 2.

### DETAILED DESCRIPTION OF THE INVENTION

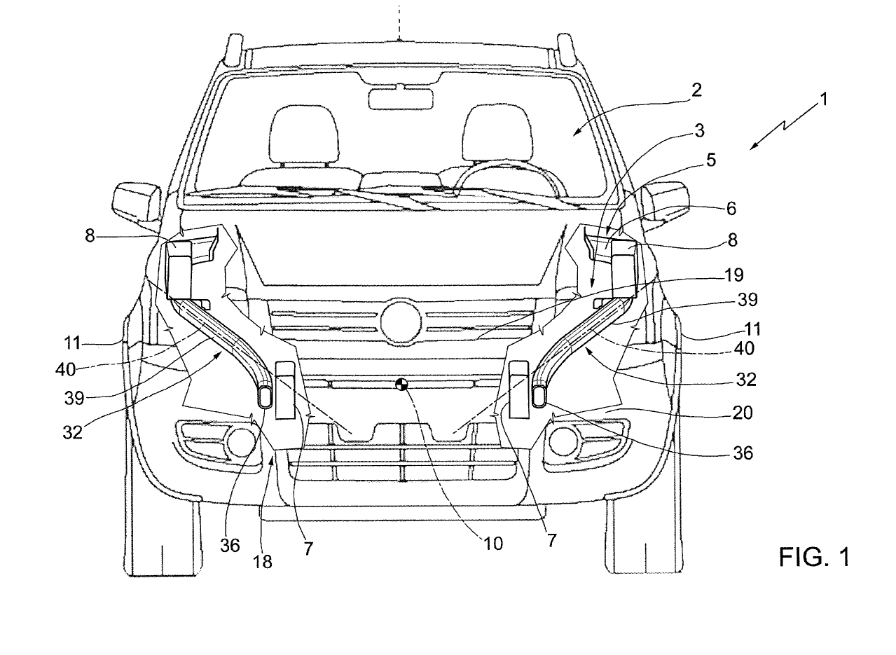

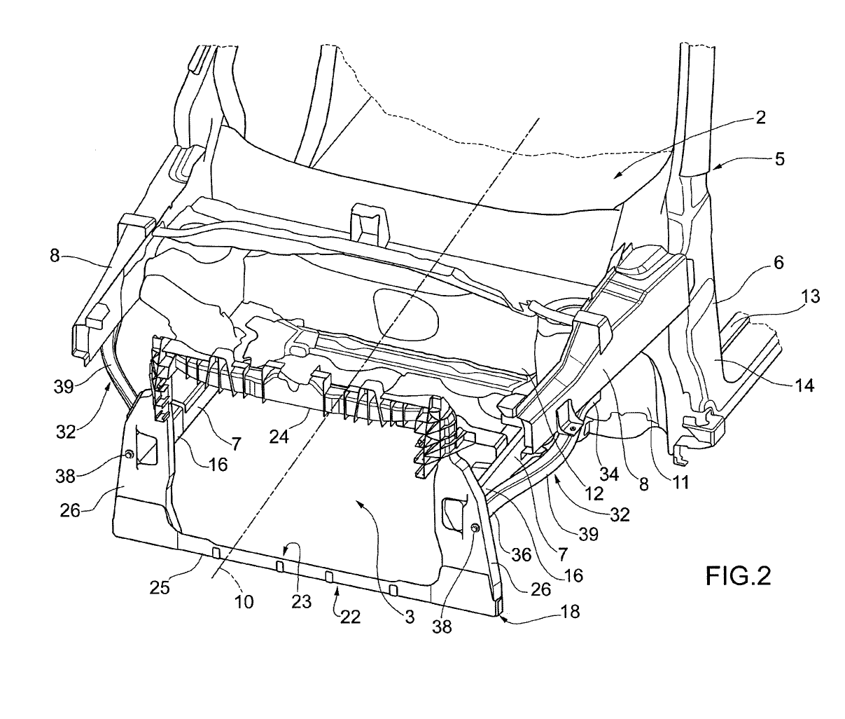

In FIG. 1, numeral 1 indicates a motor vehicle having a passenger compartment 2 and an engine compartment 3, arranged in front of a lower zone of the passenger compartment 2. The motor vehicle 1 comprises a body 5, which in turn comprises a structure 6 defining the passenger compartment 2, two primary longitudinal struts 7 and two secondary longitudinal struts 8. The struts 7, 8 are arranged in the engine compartment 3, are substantially parallel to a longitudinal axis 10 which coincides with the advancement axis of the motor vehicle 1, and extend so as to protrude from structure 6. In particular, as also shown in FIG. 2, the struts 7 are arranged lower and more inwards than the struts 8, are side by side in horizontal direction with the front wheelhouses 11 of the motor vehicle 1, define an extension of a vehicle floor 13 of structure 6, and extend so as to protrude forward, from a slightly higher point than the vehicle floor 13, starting from a substantially vertical wall 12, which is called “fire-protection panel” and delimits a lower zone of the passenger compartment 2.

On the other hand, the struts 8 are arranged over the wheelhouses 11 and extend so as to protrude from respective front vertical uprights 14, which also support, in known and not shown manner, the front side doors of the motor vehicle 1.

The front end portions of the struts 7 are indicated by numeral 16 and support a front end 18 of the motor vehicle 1 (partially shown). In particular, the front end comprises a heat exchanger assembly (not shown), a grille 19, a bumper 20 (FIG. 1) and a frame 22 (FIG. 2), which supports the heat exchanger assembly, grille 19 and bumper 20 in known and not shown manner, and defines a substantially rectangular opening 23 which at least partially accommodates the above-mentioned assembly.

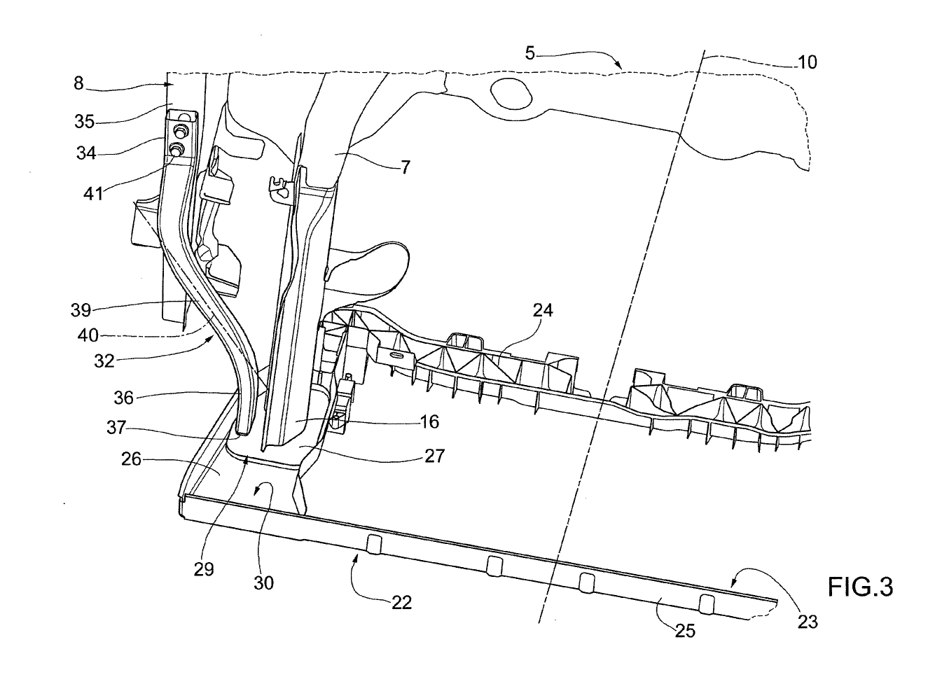

With reference to FIG. 3, frame 22 comprises an upper cross member 24, a lower cross member 25, and two lateral uprights 26, which are normally called vertical links and are fixed at the ends 16, preferably by means of the interposition of respective plates 27.

Preferably, the lateral uprights 26 are defined by respective plates, which are substantially vertical, are aligned longitudinally with the struts 7 and are provided with holes for coupling to the struts 7 and/or to the plates 27 by means of screws or bolts.

The plates 27 have respective rear faces 29, which are substantially orthogonal to the struts 7, axially rest against the ends 16 and are fixed with the latter, preferably by means of screws or welding. The plates 27 have respective front faces resting against the rear faces 30 of the lateral uprights 26 and perform a dual function: on the one hand, they stiffen the areas where frame 22 is connected to the struts 7; on the other hand, they allow respective elongated members 32 to be connected to the ends 16. In other words, the elongated members 32 define, together with the plates 27, two connection devices for constraining the ends 16 to the struts 8, in order to improve the degree of safety provided by body 5 in the event of accident with frontal crash against an obstacle or barrier in presence of a relatively small overlap between the front end of the motor vehicle 1 and such an obstacle or barrier, that is when the frontal crash involves substantially a front angle of the motor vehicle 1.

The elongated members 32 comprise respective rear terminal portions 34 which are fixed to intermediate portions 35 of the struts 8; and respective front terminal portions 36, which are parallel but separate from the ends 16. In particular, the ends 16 and the portions 36 are arranged side by side horizontally, with a relatively small intermediate gap. At the same time, the portions 36 are fixed to the plates 27, in addition to the ends 16. In particular, the lateral uprights 26 and the plates 27 are engaged by screws 38 (FIG. 2), screwed into nut screws 37 which are fixed in the portions 36, for example by means of welding. The screws 38 are therefore parallel to axis 10.

According to a not shown alternative, the portions 36 rests against a side of the ends 16 and are fixed directly to the ends 16, by means of screws and/or bolts which extend orthogonal to axis 10, possibly without the plates 27.

The elongated members 32 comprise intermediate portions 39, which join the portions 34 to the portions 36 and extend along respective directions 40 which, as also shown in FIG. 1, are substantially symmetric with respect to a vertical centerline plane and diverge from each other extending from the front end 18 backwards towards structure 6.

Therefore, not only the elongated members 32 stiffen body 5, since they connect the struts 7 to the struts 8, but they define respective deflectors or guides which help to laterally deviate the motor vehicle 1 outwards when the front end 18 frontally crashes against the obstacle or the barrier with a relatively small overlap, that is when the frontal crash mainly involves one of the two struts 8.

In particular, the intermediate portions 39 are S-shaped, that is they do not have edges for joining the portions 34 to the portions 36.

Preferably, the cross section of the elongated members 32 is constant along the directions 40. Advantageously, the elongated members 32 are defined by respective tubes, so as to give the best compromise between lightness and rigidity/resistance.

Again with reference to FIG. 3, preferably the portions 34 are parallel to the struts 8, rest on the portions 35 and are fixed to the latter by means of bolts and screws 41, which extend orthogonal to the resting surface defined by the portions 35. Preferably, the portions 34 rest on a lower face of the portions 35, therefore the screws 41 are approximately vertical. As indicated above, the screws 38 are instead parallel to axis 10: the spatial orientation difference between the axes of the screws 41 and 38 contributes to obtaining a better distribution of the stresses in the two connection areas in which the elongated members 32 are fixed, and therefore increased break resistance of such connection areas in the event of frontal crash.

As indicated above, in the event of frontal crash against an obstacle at a lateral area of relatively small amplitude, the corresponding elongated member 32 on the angle involved in the frontal crash transmits part of the stress between the struts 7 and 8 and stiffens this lateral part of body 5. At the same time, the intermediate portion 39 defines a diverter which, when hitting the obstacle, tends to cause the front end 18 to deviate laterally in the direction opposite to the obstacle during the crash, while the front end 18 and the struts 7, 8 deform plastically to absorb energy. Assuming that the obstacle is fixed, with this deviation the motor vehicle 1 tends to slightly vary the advancing direction and therefore tends to slide away laterally with respect to the obstacle.

Due to this behaviour, the effects of the misaligned frontal crash with small overlap with respect to the barrier or obstacle are reduced. In particular, the stresses on strut 8 resulting from such a crash are reduced, therefore increased safety is ensured in the passenger compartment 2 with respect to solutions lacking the members 32.

At the same time, the connection system between the screws and/or bolts, with no welding, for fixing the elongated members 32 allows this solution to be applied in the production lines, only for types of vehicles in which it is actually needed and/or is legally required to meet specific requirements in the event of a crash.

Thereby, it is possible to obtain increased standardization for different motor vehicles, without having to completely redesign bodies which are normally used. In other words, with respect to known solutions, in order to accommodate the elongated members 32 there is only necessary to drill the lateral uprights 26 and the plates 27 to ensure the fastenings defined by the screws 38, drill the portions 35 to allow the fastening of the portions 34, and possibly stiffen the portions 35.

Then, the specific above described features allow to obtain advantages of simplicity and resistance, apparent to a person skilled in the art.

Finally, it is apparent from the above that modifications and variants may be made to body 5 herein described and illustrated, without departing from the scope of protection of the present invention, as defined in the appended claims.

In particular, the cross section of the elongated members 32 could be different from the one indicated by way of example, for example such cross section might not be constant along the directions 40.

1. A motor vehicle body (5) comprising:
a structure (6) defining a passenger compartment (2);
two secondary longitudinal struts (8), which extend forward so as to protrude from said structure (6) and are substantially parallel to a longitudinal axis (10);
two primary longitudinal struts (7), which extend forward so as to protrude from said structure (6), are parallel to said longitudinal axis (10), are arranged in lower positions and more inwards than said secondary longitudinal struts (8) and comprise respective front end portions (16) adapted to support a front end (18) of the motor vehicle;
two connection devices, each of which joins a respective said front end portion (16) to a respective said secondary longitudinal strut (8); said connection devices comprising respective elongated members (32) comprising respective front and rear end portions (36, 34) and respective intermediate portions (39) extending along respective directions (40) which are substantially symmetric with respect to a vertical centerline plane and diverge, extending towards said structure (6);
characterized in that said front and rear terminal portions (36, 34) are substantially parallel to said primary and secondary longitudinal struts (7, 8), and said intermediate portions (39) are S-shaped.

2. The body according to claim 1, characterized in that said elongated members (32) have constant cross section.

3. The body according to claim 1, characterized in that said elongated members (32) are defined by tubes.

4. The body according to claim 1, characterized in that said connection devices comprise:
first fastening means (27, 37, 38) fixing said front terminal portions (36) to said front end portions (16), and
second fastening means (41) fixing said rear terminal portions (34) to intermediate zones (35) of said secondary longitudinal struts (8).

5. The body according to claim 4, characterized in that said first fastening means comprise first screws (38), and said second fastening means comprise second screws (41).

6. The body according to claim 5, characterized in that said second screws (41) extend along axes which are spatially oriented differently from said first screws (38).

7. The body according to claim 4, characterized in that said first fastening means comprise two plates (27), which are substantially orthogonal to said front end portions (16) and to said front terminal portions (16); said front end portions (16) and said front terminal portions (36) being separate from one another and being fixed to said plates (27).
